(19) United States
(12) Patent Application Publication
(10) Pub. No.: US 2023/0112429 A1
(43) Pub. Date: Apr. 13, 2023

(54) ROTOR AND MOTOR INCLUDING SAME

(71) Applicants: HYUNDAI MOTOR COMPANY, Seoul (KR); KIA CORPORATION, Seoul (KR)

(72) Inventors: Gi Pyo Kim, Seongnam-si (KR); Jae Kwang Kim, Seoul (KR); Young Hoon Jung, Seoul (KR)

(73) Assignees: HYUNDAI MOTOR COMPANY, Seoul (KR); KIA CORPORATION, Seoul (KR)

(21) Appl. No.: 17/684,037

(22) Filed: Mar. 1, 2022

(30) Foreign Application Priority Data
Oct. 8, 2021 (KR) 10-2021-0133566

(51) Int. Cl. H02K 1/32; H02K 1/276; H02K 5/15

(52) U.S. Cl. CPC H02K 1/32; H02K 1/276; H02K 5/15

(57) ABSTRACT

A motor for a vehicle includes a rotor and a pair of end plates having a first end plate and a second end plate. Each of the pair of end plates is respectively disposed on opposite sides of the rotor. At least one path extends from the first end plate to the second end plate and penetrating through the second end plate through the rotor from the first end plate.

### CROSS REFERENCE TO RELATED APPLICATION

The present application claims priority to Korean Patent Application No. 10-2021-0133566, filed Oct. 8, 2021, the entire contents of which are incorporated herein for all purposes by this reference.

### BACKGROUND

### Field of the Disclosure

The present disclosure relates to a rotor of a motor and, more particularly, to a motor for a vehicle.

### Description of the Related Art

A motor converts supplied electrical energy into kinetic energy to drive a machine. Recently, eco-friendly vehicles driven by motors have appeared.

As a drive motor for a vehicle, a permanent magnet synchronous motor (PMSM) is mainly used. The motor includes a stator that is a fixed part and a rotor that is a rotating part, and the rotor rotates by electromagnetic interaction between the stator and the rotor. In particular, for electromagnetic interaction between the stator and the rotor in the permanent magnet synchronous motor, coils are wound around the stator, and permanent magnets are disposed around the rotor.

The motor generates heat during operation, so cooling must be provided to maintain performance. For example, parts, such as blades, are mounted to the rotor to stimulate heat dissipation through gas flow inside the motor generated by rotation of the rotor. In such a method, there are problems such as the cost incurred due to the addition of parts and such as difficulty in securing space for blades.

The foregoing is intended merely to aid in understanding the background of the present disclosure. The foregoing is not intended to mean that the background falls within the purview of the related art that is already known to those having ordinary skill in the art.

### SUMMARY

Accordingly, the present disclosure has been made keeping in mind the above problems occurring in the related art. The present disclosure is intended to provide a rotor of a motor, capable of increasing an amount of heat dissipation of the motor without additional parts.

In addition, the present disclosure is intended to provide a rotor of a motor, capable of reducing a temperature of the motor through increasing heat dissipation, thereby improving durability of the motor.

Objectives of the present disclosure are not limited to the objectives mentioned above. Other objectives not mentioned herein may be clearly understood by those of ordinary skill (hereinafter ‘a person or persons of ordinary skill’) in the art to which the present disclosure belongs from the description below.

In order to achieve the above objectives of the present disclosure and to perform characteristic functions of the present disclosure as described below, features of the present disclosure are as follows.

According to one aspect of the present disclosure, a motor may include a rotor and a pair of end plates including a first end plate and a second end plate. The pair of end plates may be respectively disposed on opposite sides of the rotor. At least one path may extend from the first end plate to the second end plate through the rotor.

According to one aspect of the present disclosure, a motor may include a rotor having a plurality of sub-rotors. Each of the plurality of sub-rotors may include a flow path penetrating therethrough. The motor may include a pair of end plates respectively disposed on opposite sides of the rotor. Each end plate may include a hole penetrating therethrough. The flow path and the hole may communicate with each other.

As described above, a rotor of a motor according to the present disclosure can increase heat dissipation of the motor without additional parts.

According to the present disclosure, a rotor of a motor is capable of improving durability of the motor by reducing a temperature of the motor by increasing heat dissipation.

Effects of the present disclosure are not limited to those described above. Other effects not mentioned herein should be clearly recognized by persons of ordinary skill in the art from the following description.

### BRIEF DESCRIPTION OF THE DRAWINGS

The above and other objectives, features, and other advantages of the present disclosure should be more clearly understood from the following detailed description when taken in conjunction with the accompanying drawings, in which:

FIG. 1 is a longitudinal cross-section view illustrating a motor, in particular a rotor, according to an embodiment of the present disclosure;

FIG. 2 is a view illustrating the motor, in particular the rotor, according to an embodiment of the present disclosure;

FIG. 3 a view illustrating an end plate of the motor according to an embodiment of the present disclosure;

FIG. 4 is an enlarged view of FIG. 3;

FIG. 5 is a cross-section perspective view illustrating the motor according to an embodiment of the present disclosure;

FIG. 6 is a view illustrating flow directions of air generated inside the motor according to an embodiment of the present disclosure; and

FIGS. 7A-7C are views illustrating assemblies of sub-rotors according to an embodiment of the present disclosure.

### DETAILED DESCRIPTION

Specific structural or functional descriptions presented in embodiments of the present disclosure are only examples for the purpose of describing the embodiments according to the concept of the present disclosure. The embodiments according to the concept of the present disclosure may be implemented in various forms. In addition, the present disclosure should not be construed as being limited to the embodiments described herein and should be understood to include all modifications, equivalents, and substitutes included in the spirit and scope thereof.

Meanwhile, in the present disclosure, terms such as first and/or second may be used to describe various components, but the components are not limited by the terms. Such terms are used only for the purpose of distinguishing one component from other components. For example, within the scope of, not departing from the scope of, the rights according to the concept of the present disclosure, the first component may be named as the second component, and similarly, the second component may also be referred to as the first component.

When a component is referred to as being “connected to” or “contacting” another component, it should be understood that the component may be directly connected to or contacting another component, but also that other components may exist in between. On the other hand, when a component is referred to as being “directly connected to” or “in direct contact with” another element, it should be understood that no other component exists therebetween. Other expressions for describing a relationship between components, i.e., “between” and “immediately between” or “adjacent to” and “directly adjacent to” should be interpreted similarly.

Like reference numerals refer to like components throughout the specification. Also, the terms used herein are for the purpose of describing the embodiments are not intended to limit the present disclosure. In the present specification, a singular form also includes a plural form unless otherwise specified in the phrase. As used herein, “comprises” and/or “comprising”, “includes” and/or “including, “has” and/or “having”, and the like mean that the stated component, step, operation, and/or element do not exclude the presence or addition of one or more other components, steps, operations, and/or elements. When a component, device, element, or the like of the present disclosure is described as having a purpose or performing an operation, function, or the like, the component, device, or element should be considered herein as being “configured to” meet that purpose or to perform that operation or function.

Hereinafter, the present disclosure is described in detail with reference to the accompanying drawings.

As mentioned above, a motor includes a stator and a rotor. Coils are wound on the stator and permanent magnets are provided on the rotor. A magnetic field generated by a current applied to the coils of the stator and the permanent magnets interact with each other, causing the rotor to rotate. In an embodiment, the motor according to the present disclosure may be an interior permanent magnet synchronous motor (IPMSM) in which the permanent magnets are inserted into the rotor.

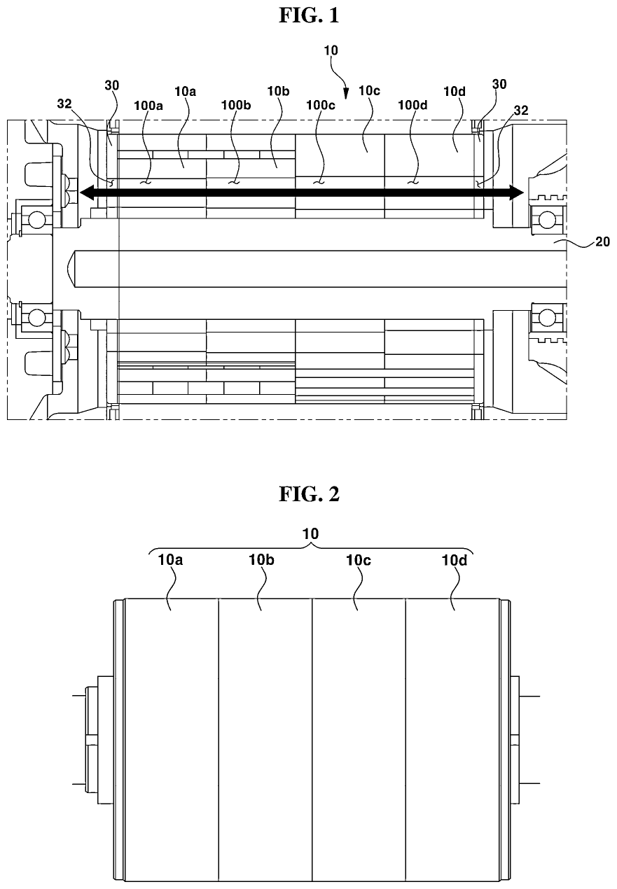

FIGS. 1 and 2 show a rotor 10 of a motor. The rotor 10 is rotatably mounted together with a shaft 20 disposed radially inward of the rotor 10. In addition, permanent magnets are mounted on the rotor 10 along a circumferential direction of the rotor 10.

According to an embodiment of the present disclosure, the rotor 10 includes a plurality of sub-rotors 10a, 10b, 10c, 10d. The plurality of sub-rotors 10a, 10b, 10c, 10d may be seen as divided rotors 10. In other words, each of the sub-rotors 10a, 10b, 10c, 10d has the same shape and includes the same configuration as the rotor 10 but each sub-rotor is configured to have an axial length smaller than that of the rotor 10. Consequently, the axial length of the rotor 10 and a sum of the axial lengths of the plurality of sub-rotors 10a, 10b, 10c, 10d may be equal.

The rotor 10 including four sub-rotors 10a, 10b, 10c, 10d is shown in FIGS. 1 and 2. However, the number of the sub-rotors 10a, 10b, 10c, 10d is not limited thereto, and the number may be increased or decreased according to design conditions.

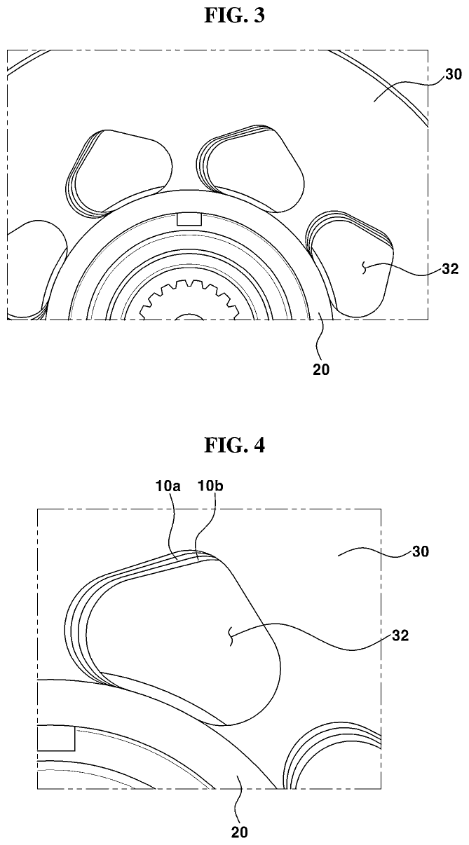

The sub-rotors 10a, 10b, 10c, 10d have flow paths 100a, 100b, 100c, 100d, respectively. The flow paths 100a, 100b, 100c, 100d penetrate the respective sub-rotors 10a, 10b, 10c, 10d along an axial direction of the sub-rotors 10a, 10b, 10c, 10d. The flow paths 100a, 100b, 100c, 100d may be provided at positions radially inward from the circumferences of the sub-rotor 10a, 10b, 10c, 10d, respectively, by a predetermined distance. In addition, a plurality of flow paths may be provided in each of the sub-rotors 10a, 10b, 10c, 10d. For example, in each of the sub-rotors 10a, 10b, 10c, 10d, a plurality of flow paths 100a, 100b, 100c, 100d may be provided. The plurality of flow paths in each sub-rotor is spaced apart from each other in a circumferential direction of the sub-rotor (see FIGS. 3 and 4). According to an embodiment of the present disclosure, the flow paths 100a, 100b, 100c, 100d may be openings that are pre-formed in the rotor 10 for weight reduction. According to an embodiment of the present disclosure, the flow paths 100a, 100b, 100c, 100d may be openings provided in the rotor 10 specifically for internal air flow.

With reference back to FIG. 1, as described above, each of the sub-rotors 10a, 10b, 10c, 10d is assembled radially outward of the shaft 20 to form one rotor 10. Each of the sub-rotors 10a, 10b, 10c, 10d constitutes the rotor 10, while the flow paths 100a, 100b, 100c, 100d of the sub-rotors 10a, 10b, 10c, 10d are configured to extend obliquely along a longitudinal direction of the rotor 10.

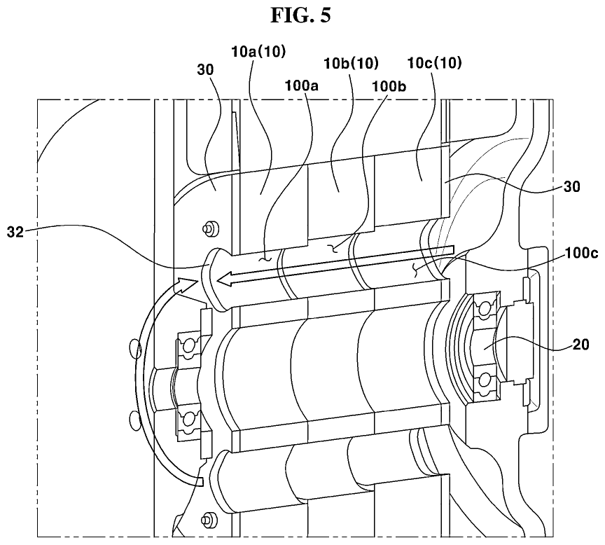

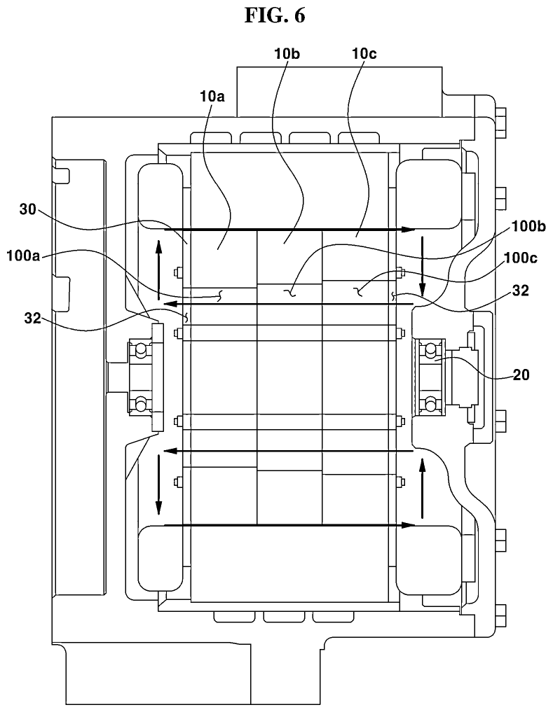

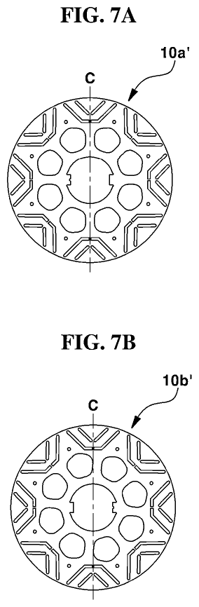

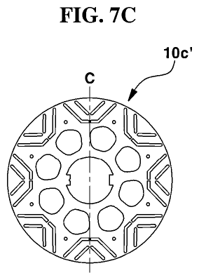

More specifically, as shown in FIGS. 5 and 6, each of the flow paths 100a, 100b, 100c, 100d is disposed at a different rotational position or angle with respect to each other. Specifically, each of the flow paths 100a, 100b, 100c, 100d is differently rotated, i.e., differently rotationally offset, with respect to a sectional center line C passing through a center of the cross-section of the rotor 10 (C is indicated in FIGS. 7A-7C). For example, the flow path 100a of a first sub-rotor 10a, which is one of the sub-rotors 10a, 10b, 10c, 10d, is rotated by a first, positive angle with respect to the sectional center line C. The flow path 100b of a second sub-rotor 10b mounted adjacent to the first sub-rotor 10a is rotated by a second angle greater than the first angle with respect to the sectional center line C. Accordingly, each of the flow paths 100a, 100b, 100c, 100d in the sub-rotors 10a, 10b, 10c, 10d may be disposed to partially overlap each other without completely overlapping with each other. As such, each of the flow paths 100a, 100b, 100c, 100d in the sub-rotors 10a, 10b, 10c, 10d is formed obliquely along the rotor 10 to generate an internal gas flow and increase an amount of heat dissipation of the motor. In other words, the rotational offset of the openings that form the flow paths 100a, 100b, 100c, and 100d act in a manner to cause gas or air movement along the flow paths through the rotor 10. Ultimately, this may increase the motor's internal heat dissipation, thereby enhancing durability of the motor and improving operational efficiency thereof.

End plates 30 are mounted at each side of the rotor 10. The end plates 30 are disposed at opposite ends in an axial direction of the rotor 10. The end plates 30 are provided to fix the rotor 10 in the axial direction and to prevent leakage of the axial magnetic flux.

According to an embodiment of the present disclosure, each end plate 30 has a plurality of holes 32. Each end plate 30 is provided with a plurality of holes 32 spaced apart along a circumferential direction thereof. In general, an end plate of a conventional motor is not provided with a hole 32 such as is provided in the present disclosure. According to the present disclosure, the flow paths 100a, 100b, 100c, 100d formed obliquely along the rotor may be opened through opposite ends of the motor, i.e., through the end plates 30, thereby facilitating heat dissipation of the motor. In addition, the openings for weight reduction provided in the rotor may be utilized as the flow paths 100a, 100b, 100c, 100d, so the heat dissipation of the motor may be increased without an additional process.

As such, the holes 32 of the end plates 30 are configured to communicate with the respective flow paths 100a, 100b, 100c, 100d. The holes 32 and the flow paths 100a, 100b, 100c, 100d may be configured to at least partially overlap each other along the longitudinal direction of the rotor 10. Also, the holes 32 of the end plates 30 may be configured to completely overlap or align with directly adjacent flow paths, respectively.

According to one embodiment of the present disclosure, the number of the holes 32 formed in each of the end plates 30 along the circumferential direction of the respective end plates 30 and the number of the flow paths 100a, 100b, 100c, 100d formed along the circumferential direction of each of the sub-rotors 10a, 10b, 10c, 10d may match. According to one embodiment of the present disclosure, the shape of each of the holes 32 and the shape of an associated one of the flow paths 100a, 100b, 100c, 100d do not have to be the same but are configured to be in shapes to at least partially overlap with each other. Accordingly, air may flow from one side of the rotor 10 to the opposite side of the rotor 10 through the holes 32 and the flow paths 100a, 100b, 100c, 100d. The flow paths 100a, 100b, 100c, 100d of the sub-rotors 10a, 10b, 10c, 10d are disposed at different angles with respect to the sectional center line C of the rotor 10. Thereby, a substantially spiral passage is formed along the rotor 10 from the holes 32 at one side of the rotor 10 communicating with the flow paths 100a, 100b, 100c, 100d to the holes 32 at the other side of the rotor 10 as the holes 32 at one side of the rotor 10, the flow paths 100a, 100b, 100c, 100d and the holes 32 at the other side of the rotor 10 partially overlap with their respective neighboring holes and flow paths.

Accordingly, the air may always flow as indicated by the arrow in FIG. 1, and the amount of heat dissipation may be increased. As shown in FIG. 5, when the rotor 10 rotates clockwise (the curved arrow in FIG. 5), a flow of the air is generated inside the motor in a direction denoted by the linear arrow in FIG. 5 and the amount of heat dissipation is increased. Conversely, when the rotor 10 rotates counterclockwise, the flow of the air is generated along an opposite direction of the linear arrow in FIG. 5.

When the respective shapes of the sub-rotors 10a, 10b, 10c, 10d are different from each other, it may be necessary to manufacture a separate mold for each of the sub-rotors 10a, 10b, 10c, 10d. However, according to the present disclosure, fewer molds may be needed than the number of the sub-rotors 10a, 10b, 10c, 10d to produce paths that extend obliquely with respect to the axial direction of the rotor 10. For example, when three sub-rotors are used, as shown in FIGS. 7A-7C, it is sufficient to prepare a total of two molds. One of the two molds is for a reference sub-rotor 10a′, which may be shown as a reference. Another mold of the two molds is for side sub-rotors 10b′, 10c′ assembled on each side of the reference sub-rotor 10a′. Here, one side sub-rotor 10b′ is disposed on one side of the reference sub-rotor 10a′. Another side sub-rotor 10c′ is disposed on the other side of the reference sub-rotor 10a′. The side sub-rotor 10c′ is different from the side sub rotor 10b′ only in that the side sub-rotor 10c′ is one that is the same as the side sub rotor 10b′ flipped over.

In a similar manner, when four sub-rotors are provided, only two molds need to be manufactured. One of the two molds is for a reference sub-rotor, and the other of the two molds is for side sub-rotors. When five sub-rotors are provided, three molds for the sub-rotors are needed. A first mold of the three molds is for a reference sub-rotor disposed in the middle of the motor, a second mold is for side sub-rotors to be disposed on opposite sides of the reference sub-rotors, and a third mold is for end-side sub-rotors to be disposed on each end side of the motor.

According to the present disclosure, the holes 32 of the end plates 30 and the flow paths 100a, 100b, 100c, 100d are at least partially overlapped to form paths along the rotor. The paths are configured to extend in a spiral direction or obliquely in the rotor 10, which generates a gas flow inside the rotor 10, thereby increasing heat dissipation. Accordingly, it is possible to enhance the durability of the motor and improve the efficiency thereof.

In addition, according to the present disclosure, components, such as blades and the like, for an internal gas flow may be omitted. Accordingly, additional space requirements and cost for the blades may be avoided.

According to the present disclosure, the amount of heat dissipation additionally secured through the holes 32 of the end plates and the flow paths 100a, 100b, 100c, 100d may further reduce the internal temperature of the motor, thereby improving the durability of the motor.

The present disclosure described above is not limited by the above-described embodiments and the accompanying drawings. It should be clear to those having the knowledge of the technical field to which the present disclosure pertains, i.e., persons of ordinary skill in the art, that various substitutions, modifications, and changes are possible within the scope without departing from the technical spirit of the present disclosure.

What is claimed is:

1. A motor comprising:
a rotor;
a pair of end plates including a first end plate and a second end plate, wherein the pair of end plates are respectively disposed on opposite sides of the rotor; and
at least one path extending from the first end plate to the second end plate through the rotor.

2. The motor of claim 1, wherein the path is formed obliquely with respect to a longitudinal direction of the rotor.

3. The motor of claim 1, wherein the rotor comprises a plurality of sub-rotors,
wherein each of the plurality of sub-rotors is provided with at least one flow path constituting the path and penetrating therethrough.

4. The motor of claim 3, wherein the plurality of sub-rotors comprises a first sub-rotor and a second sub-rotor adjacent to the first sub-rotor, and
wherein at least one first flow path of the first sub-rotor and at least one second flow path of the second sub-rotor are configured to partially overlap with each other.

5. The motor of claim 4, wherein the first flow path and the second flow path have the same cross section.

6. The motor of claim 4, wherein the first end plate is disposed adjacent to the first sub-rotor,
wherein the path comprises a first hole passing through the first end plate, and
wherein the first hole, the first flow path, and the second flow path are configured to partially overlap with each other.

7. The motor of claim 6, wherein the second end plate is disposed adjacent to the second sub-rotor,
wherein the path comprises a second hole penetrating through the second end plate, and
wherein the first hole, the first flow path, the second flow path, and the second hole are configured to partially overlap with each other.

8. The motor of claim 3, wherein the flow path comprises a plurality of flow paths spaced apart from each other along a circumferential direction of each of the plurality of sub-rotors.

9. The motor of claim 3, wherein the plurality of sub-rotors comprises:
a reference sub-rotor having a first flow path provided at a position rotated by a preset first angle with respect to a vertical center line of a cross-section of the rotor; and
a pair of side sub-rotors, each having a second flow path provided at a position rotated by a second angle smaller than the preset first angle with respect to the vertical center line.

10. A manufacturing method of the motor according to claim 9, the method comprising:
disposing the reference sub-rotor;
disposing a first side sub-rotor on a first side of the reference sub-rotor; and
disposing a second side sub-rotor on a second side of the reference sub-rotor,
wherein the first side sub-rotor and the second side sub-rotor have the same shape, but the first side sub-rotor and the second side sub-rotor are disposed to be rotationally symmetrical.

11. The motor of claim 1, wherein each of the pair of end plates comprises a hole constituting the path and penetrating the respective end plate.

12. The motor of claim 11, wherein the hole comprises a plurality of holes spaced apart from each other along a circumferential direction of each of the pair of end plates.

13. The motor of claim 1, wherein the motor is an interior permanent magnet synchronous motor.

14. A motor comprising:
a rotor having a plurality of sub-rotors, wherein each of the plurality of sub-rotors incudes a flow path penetrating therethrough; and
a pair of end plates disposed on opposite sides of the rotor, wherein each end plate of the pair of end plates has a hole penetrating therethrough,
wherein the flow path and the hole communicate with each other.

15. The motor of claim 14, wherein the flow path and the hole are formed obliquely with respect to an axial direction of the rotor.

16. The motor of claim 14, wherein each of the flow paths of the plurality of sub-rotors is at least partially overlapped with the flow paths adjacent thereto, and each hole of the pair of end plates and the flow path adjacent thereto are at least partially overlapped with each other.
